(19) United States
(12) Patent Application Publication
(10) Pub. No.: US 2016/0257252 A1
(43) Pub. Date: Sep. 8, 2016

(54) PROJECTION OF IMAGES ON SIDE WINDOW OF VEHICLE

(71) Applicant: Lenovo (Singapore) Pte. Ltd., New Tech Park (SG)

(72) Inventors: Grigori Zaitsev, Durham, NC (US); Russell Speight VanBlon, Raleigh, NC (US)

(21) Appl. No.: 14/639,263

(22) Filed: Mar. 5, 2015

(51) Int. Cl. B60R 1/00; G06K 9/00

(52) U.S. Cl. CPC B60R 1/001; G06K 9/00791; B60R 2300/205; B60R 2300/605; B60R 2300/8046

(57) ABSTRACT

In one aspect a vehicle includes a vehicle body, a processor, a camera disposed on the vehicle body which is accessible to the processor, at least one window onto which at least one image is presentable, and memory. The memory comprises instructions executable by the processor to receive data from the camera and, based at least in part on the data, present on the window at least one image corresponding to a representation of a field of view of a mirror. The field of view is identified at least in part based on a current position of at least a portion of a driver.

### FIELD

The present application relates generally to projection of images on a side window of a vehicle.

### BACKGROUND

Side view mirrors on vehicles account for a significant amount of wind resistance on the vehicle, thus diminishing (e.g. fuel) efficiency of the vehicle. There are currently no adequate solutions for addressing the foregoing while also sot depriving a driver of the vehicle of the perspective provided by such side view mirrors.

### SUMMARY

Accordingly, in one aspect a device includes at least one processor, at least one camera accessible to the processor, at least one projector accessible to the processor, and at least one memory accessible to the processor. The memory bears instructions executable by the processor to receive data from the camera and, based at least in part on the data, control the projector to project at least one image on at least a portion of a driver side window of a vehicle.

In another aspect, a method includes receiving at least one image from a camera and, at least in part based on the at least one image, presenting on a display a representation of a field of view of a side view mirror of a vehicle.

In still another aspect a device includes at least one processor, at least one camera accessible to the processor, at least one display accessible to the processor, and at least one memory accessible to the processor. The memory bears instructions executable by the processor to receive data from the earners and, based at least in part on the data, control the display to present at least one image on at least a portion of a window of a vehicle.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIGS. 3-6 are flow charts showing example algorithms in accordance with present principles;

FIGS. 7-10 are example illustrations in accordance with present principles; and

FIG. 11 is an example user interface (UI) in accordance with present principles,

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interlaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hand-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive date. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and B together, B and C together, and/or A, B, and C together, etc.

The term “circuit” or “circuitry” is used in the summary, description, and/or claims. As is well known in the art, the term “circuitry” includes ail levels of available integration, e.g., from discrete logic circuits to the highest level of circuit integration such as VLSI, and includes programmable logic, components programmed to perform the functions of an embodiment as well as general-purpose or special-purpose processors programmed with instructions to perform those functions.

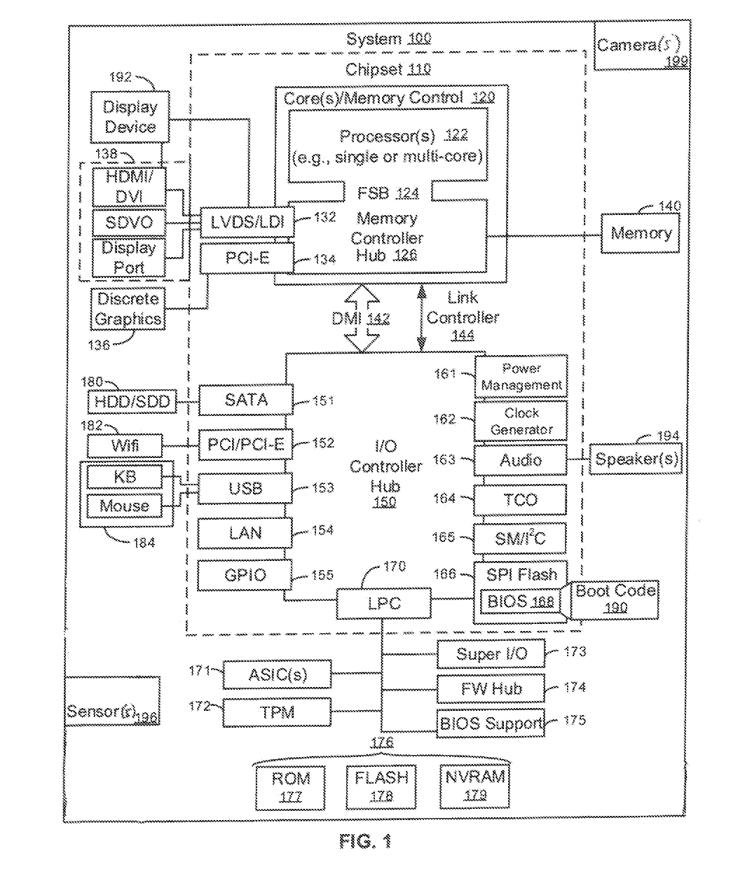

Now specifically in reference to FIG. 1, it shows an example block diagram, of an information handling system and/or computer system 100 (e.g. coupled to and/or integrated with a vehicle). Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. a game console such as XBOX® or Playstation®.

As shown in FIG. 1, the system 100 includes a so-called, chipset 110. A chipset refers to a group of integrated circuits, or chips, that are designed to work together, Chipsets are usually marketed as a single product (e.g., consider chipsets marketed under the brands INTEL®, AMD®, etc.).

In the example of FIG. 1, the chipset 110 has a particular architecture, which, may vary to some extent depending on brand or manufacturer. The architecture of the chipset 110 includes a core and memory control group 120 and an I/O controller hub 150 that exchange information (e.g., data, signals, commands, etc.) via, for example, a direct, management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc,) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., an at least partially transparent display and/or projector (e.g. a so-called “heads up” display), a CRT, a flat panel, a projector, and/or a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including e.g. one of more GPUs). An example system may include AGP or PCI-E for support of graphics.

The I/O hub controller ISO includes a variety of interfaces. The example of FIG. 1 includes a SATA interlace 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc, under direction of the processors) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interlace (e.g., a multi-master serial computer bus interface) 165, and a serial peripheral flash memory/controller interface (SPI Flash) 166, winch, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interlace.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to fee e.g. tangible computer readable storage mediums that may not be transitory signals. The I/O hub controller ISO may also include an advanced host controller interface (AHCI) to support one or more drives 180. The PCI-E interface 152 allows for wireless connections 182 to devices, networks, etc. The USB interface 153 provides tor input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 of FIG. 1 may also include one or more proximity sensors, infrared transceivers, and/or -sonar and/or ultrasound transceivers 196 providing input to the processor 122 and configured in accordance with present principles for sensing e.g. proximity of one or more moving and/or unmoving objects (e.g. relative to the system 100) such as e.g. other vehicles, people, etc. Furthermore, the system 100 of FIG. 1 may include one of more cameras 199 for gathering one or more images and providing input related thereto to the processor 122. The camera may be, e.g., a three dimensional (3D) imaging camera, a thermal imaging camera, a digital camera such as a webcam, and/or a camera integrated into the system 100 and controllable by the processor 122 to gather pictures/images and/or video of one or more people in accordance with present principles.

Additionally, though, now shown for clarity, in some embodiments the system 100 may include a gyroscope for e.g. sensing and/or measuring the orientation of the system 100 and providing input related thereto to the processor 122, an accelerometer for e.g. sensing acceleration and/or movement of the system 100 and providing input related thereto to the processor 122, and an audio receiver/microphone providing input to the processor 122 e.g. based on a user providing audible input to the microphone. Still further, and also not shown for clarity, the system 100 may include a GPS transceiver that is configured to e.g. receive geographic position information from at least one satellite and provide the information to the processor 122. However, it is to be understood that another suitable position receiver other than a GPS receiver may be used in accordance with present principles to e.g. determine the location of the system 100.

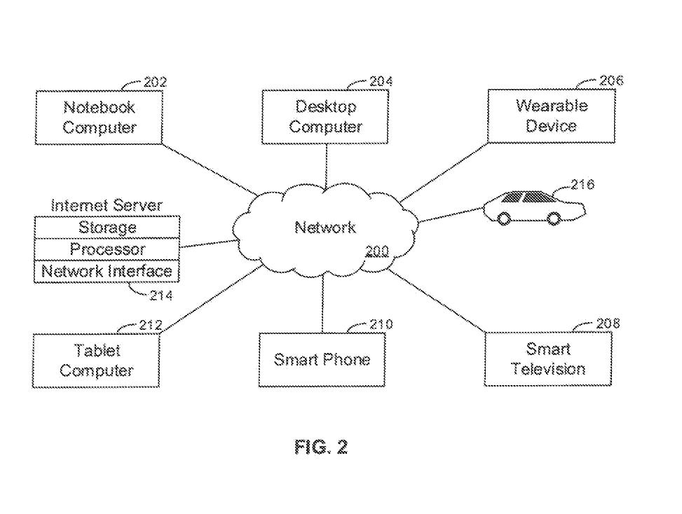

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 210, a tablet computer 212, and a vehicle 216. The vehicle 216 may comprise some or all of the components discussed herein (e.g. discussed above with respect to the system 100).

In addition to the foregoing, the network 200 includes a server 214 such as e.g. an Internet server that may e.g. provide cloud storage accessible to the devices 202-212 and 216. It is to be understood that, the devices 202-216 are configured to communicate with each other over the network 200 to undertake present principles.

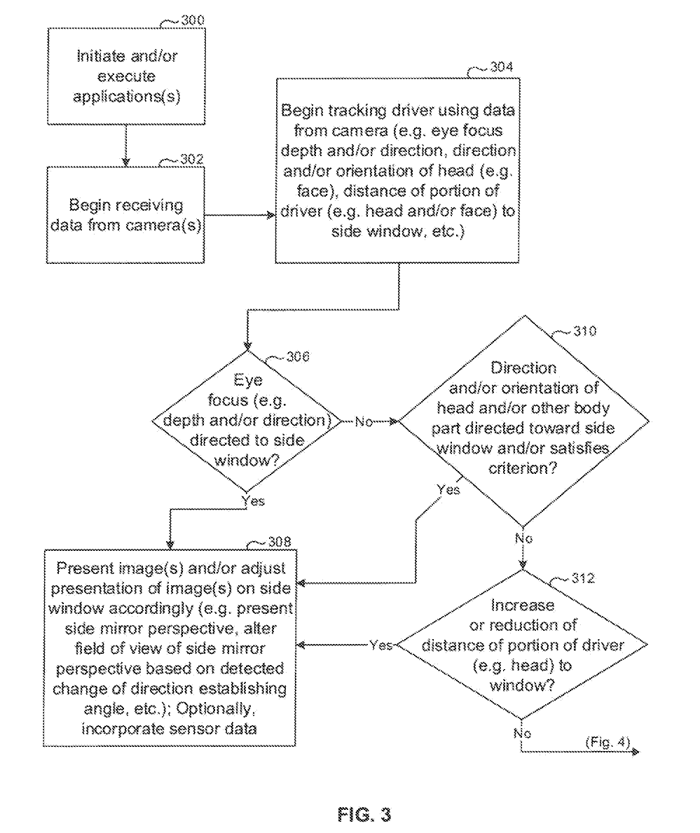

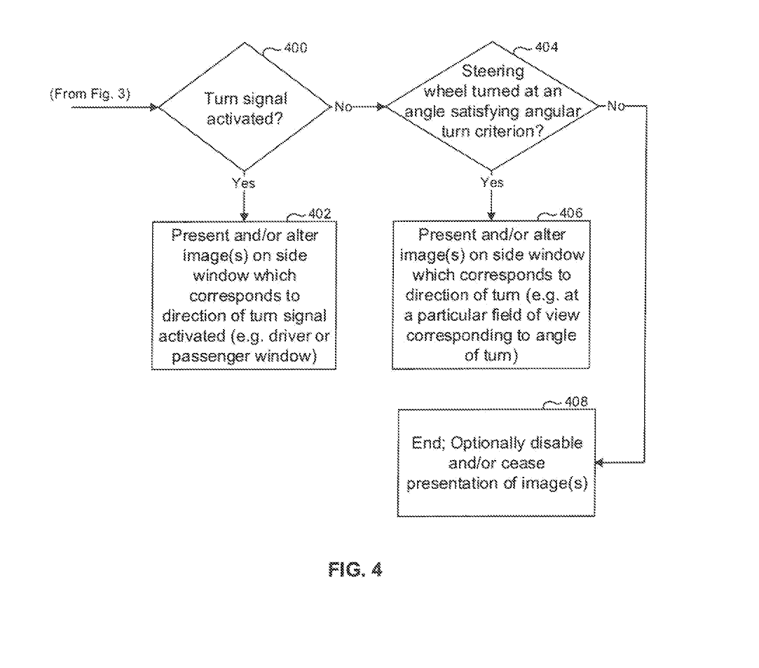

Referring to FIG. 3, it shows example logic that may be undertaken by a device such as the system 100 and/or a vehicle in accordance with present principles. Beginning at block 300, the logic initiates and/or executes one or more applications for undertaking present principles. The logic then moves to block 302, where the logic begins receiving data from e.g. plural cameras in accordance with present principles, such as e.g. data from a camera gathering images of a driver of a vehicle in which the camera is disposed and data from a camera gathering images corresponding to a perspective that the driver would otherwise see should he be looking (e.g. from the driver's seat) out a driver side window and at a driver side mirror (e.g. that may not actually be present on the vehicle). Thus, in some embodiments the camera may be mounted on a portion of the vehicle at or near where the hood of the vehicle meets the upper portion of the frame of the vehicle establishing the passenger compartment and a side door of the vehicle (e.g. outside the passenger compartment where a side view minor would otherwise be disposed even if not actually included on the vehicle to reduce wind resistance on the vehicle when it moves).

In any case, from block 302 the logic moves to block 304. At block 304 the logic begins tracking the driver's movement(s), direction(s) and/or orientation(s) of the drivers' head (e.g. and specifically, the driver's face), eye focus depth and eye focus direction, distance of at least a portion of the driver to the driver side window and/or dashboard of the vehicle, etc. using the data received from the camera gathering images of the driver. These things may be tracked and analyzed by the logic e.g. using facial and body recognition principles and software, gesture recognition principles and software, eye tracking principles and software, proximity detection principles and software, movement detection principles and software, etc.

From block 304 the logic proceeds to decision diamond 306, where the logic determines, based on the image(s) from the camera(s) at least partially showing at least a portion of the driver, whether the driver's eye focus depth and direction are directed at least toward if not at an area (e.g. corner) of a side window of the vehicle in which the driver is disposed (e.g. a driver side window or a passenger side window), such, as within a threshold number of degrees of being focused directly at a particular point or area of the window. A negative determination causes the logic to move to decision diamond 310, which will be described shortly. However, responsive to an affirmative determination at diamond 306, the logic moves to block 308 where the logic presents on the side window (e.g. on an at least partially transparent display integrated with and/or coupled to the side window) one or more images (e.g. a real time video feed) from the camera which has gathered images corresponding to a perspective that the driver would otherwise see should he be looking (e.g. from the driver's seal) out a driver side window and at a driver side mirror (if one existed). Note that in some embodiments, the logic may have already been presenting some images, and in such a case the logic may alter the presentation of the images responsive to the affirmative determination at diamond 306.

For instance, at block 308 the logic may present on the side window a perspective the driver would see if a side view mirror were present on the same side of the vehicle as the side window being looked at. As another example, the logic may alter the presentation of images from presenting images of a first field of view of a side mirror perspective So presenting images of a second, different field of view of a different side mirror perspective of the same side mirror based on a detected change of direction and/or orientation of the driver's head which establishes a different viewing angle of the driver's eyes toward the point and/or area of the side window being looked at.

Before moving on in the description of FIG. 3, also note that at block 308 the logic may incorporate into and/or enhance the images and/or representations it presents on the side window with sensor data from one or more proximity sensors, infrared transceivers, sonar and/or ultrasound transceivers, three dimensional cameras (it being also understood that in some embodiments the camera from which the images presented on the side window were received may in tact be a three dimensional camera), etc. to thus mo re realistically represent to the driver actual spatial distances between objects shown in the images. Accordingly, in some embodiments at block 308 the logic may present e.g. computer-generated images and/or representations of side view mirror perspective that include three dimensional representations of objects and/or that portray spatial distances between objects and/or between an object and the vehicle (e.g. using data from one or more of a three dimensional camera, a proximity sensor, an infrared sensor, an ultra sound transceiver, etc.).

Referring back to decision diamond 306, as mentioned above, should a negative determination be made thereat, the logic moves from decision diamond 306 to decision diamond 310, at which the logic determines, based on the image(s) received from the camera(s), whether a direction and/or orientation of the driver (e.g. of their head and/or face, in particular) has changed and/or is directed at least toward the side window and/or whether a direction and/or orientation of the driver satisfies a particular body orientation criterion (e.g. that the driver's head is turned a predetermined and/or threshold number of degrees toward the side window relative to an axis parallel to the orthogonal of a plane established by the driver's torso (e.g. the driver's chest facing forward toward the front of the vehicle), that the driver's orientation is recognized as a command to present images, etc.). As shown in FIG. 3, an affirmative determination at diamond 310 causes the logic to move to block 308 and undertake an action in accordance with the description of block 308 from above (e.g. alter the field of view of images being presented to show a side view mirror perspective in a way corresponding to the change in body orientation such as e.g. altering the field of view by an angle corresponding to an angle establishing the change in orientation), while a negative determination, at diamond 310 instead causes the logic to move to decision diamond 312.

However, before describing diamond 312, it is to be understood that while in some embodiments, body orientation criterion may be established, identifiable, and/or satisfied based on e.g. recognition, of the driver's head as being oriented at a turn, of X degrees toward the driver side window (e.g. relative to the driver facing straight ahead while sitting upright and feeing the windshield), it may in addition to that or in lieu of that be established, identifiable, and/or satisfied based on recognition of the driver's eyes as being oriented at an angle of X degrees with respect to the forward-facing axis of the head (e.g. forward-facing toward the front windshield).

Now describing diamond 312, the logic determines thereat whether the driver has increased or reduced the distance between a portion of their body (e.g. their head and/or face) and a portion of the vehicle, such as the side window itself and even e.g. a predetermined point or area of the side window (e.g. a front, bottom corner of the side window out of which the driver would look at a side mirror if one were actually present). An affirmative determination at diamond 312 causes the logic to move to block 308 (e.g. to increase the size of the area of the display and hence side window that presents the images, and/or to magnify and/or zoom in on a particular area of the images identified as being looked at by the driver while keeping the total area of presentation at least substantially the same, should the driver move closer to the window; e.g. to decrease the size of the area of the display and hence side window that presents the images, and/or to zoom out from a perspective and/or field of view being shown while keeping the total area of presentation at least substantially the same, should the driver move away from the window).

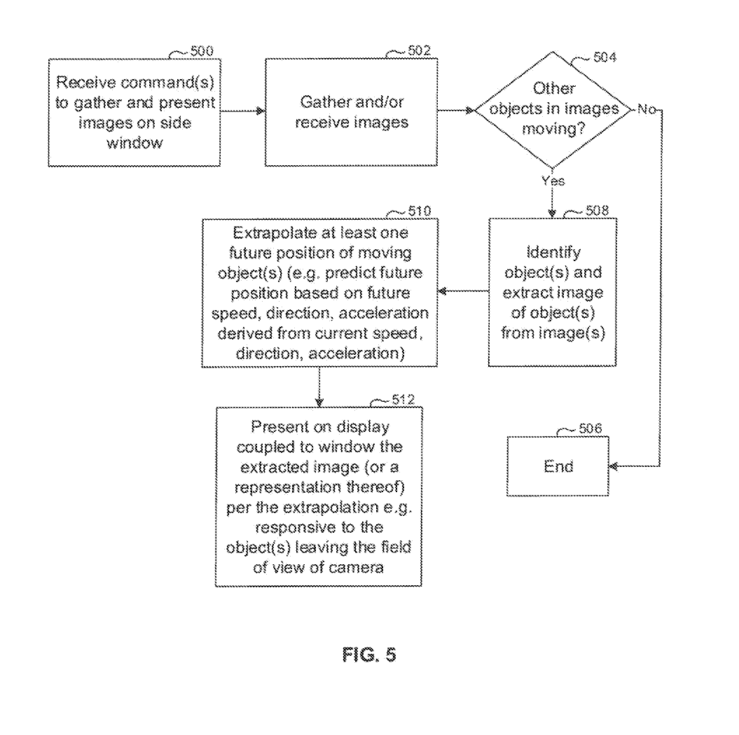

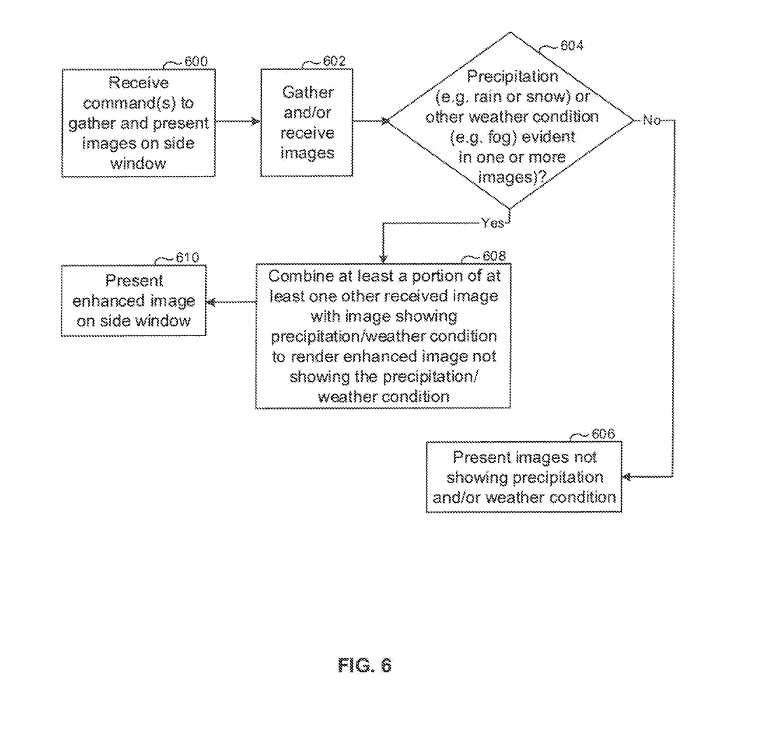

However, a negative determination may cause the logic to end, or proceed to the diamonds and blocks shown in FIG. 4. Thus, it is to be understood that that logic of FIG. 4, and indeed of FIGS. 5 and 6 as well, may be executed in conjunction with FIG. 3 and with each other in. any suitable way to undertake present principles.

In any case, now describing FIG. 4, at decision diamond 400 the logic determines whether a turn signal of the vehicle has been activated. Responsive to an affirmative determination at diamond 400 (and/or responsive to an affirmative determination that the driver has looked at the predetermined area of the side window within a threshold time before or after activating the turn signal), the logic moves to block 402 where the logic presents and/or alters the field of view of already presented images of a side mirror perspective corresponding to the same side as the turn signal indication (e.g. to show the perspective of a side view mirror encompassing an area including a predetermined “blind” spot of the vehicle relative to the driver's head rather than a different perspective of the side view mirror presented prior to activation of the turn signal that does not show the blind spot). For instance, in a vehicle in which the driver side is the left side of the vehicle (e.g. such as is the standard in the United States and much of Europe), should the driver activate the right turn signal, the logic may in response present a perspective of a passenger side mirror including an area recognized as a blind spot for the driver (e.g. based on a previous configuration by the driver), where no perspective of a side view mirror may have been presented on the passenger side window prior to activation of the right turn signal.

However, should a negative determination be made at diamond 400, the logic instead moves to decision diamond 404 rather than block 402. At diamond 404, the logic determines whether a steering wheel of the vehicle has been turned e.g. any amount, a threshold amount, and/or at an angle satisfying an angular turn criterion (e.g. a threshold number of degrees from its previous orientation within a predetermined and/or threshold time frame, an absolute number of degrees from being oriented upright to steer the vehicle straight ahead, etc.). An affirmative determination at diamond 404 causes the logic to move to block 406, where the logic presents images on a side window corresponding to the direction of the turn (e.g. a left turn causes the logic to present such images on a left passenger window relative to feeing forward in the vehicle) and/or alters presentation of images that may be presented on such a side window. For instance. In some embodiments the change in the number of degrees the vehicle itself turns in response to the turn left or right of the steering wheel, and/or the number of degrees of the turn left or right of the steering wheel itself, may correspond to at least substantially the same number of degrees left or right of alteration of presentation of the perspective and/or field of view of a side mirror presented on the side window.

However, note that a negative determination at diamond 404 instead causes the logic to move to block 408, where the logic may end, and/or optionally may disable and/or cease presentation of images on a side window on which they were being presented.

Continuing the detailed description in reference to FIG. 5, it shows example logic that may be undertaken by a device such as the system 100 and/or a vehicle in accordance with present principles. Beginning at block 500, the logic determines to and/or receives a command to gather and present images on a side window in accordance with present principles. The logic then moves to block 502 where images for presentation are received and/or gathered. Thereafter, the logic moves to decision diamond 504, at which the logic determines whether one or more objects in the images are moving objects (e.g. at all, or relative to the vehicle) e.g. using movement recognition principles and/or software. A negative determination at diamond 504 causes the logic to move to block 506 where the logic may end. However, an affirmative determination at diamond 504 instead causes the logic to move to block 508, where the logic may identify and/or extract from the image(s) an image and/or representation of (e.g. only) the object(s) that is moving (e.g. using object recognition principles and/or software). In some embodiments, if plural objects are identified as moving, the logic may extract and establish separate images and/or representations of each moving object.

From block 508 the logic moves to block 510, where the logic extrapolates at least one future position of the moving object. E.g. at block 510 the logic may (e.g. responsive to the object based on its own movement relative to the vehicle exiting the field of view of the image(s)) extrapolate at least one future position of the moving object based on predictions of one or more of a future speed of the object, a future direction of motion of the object, and/or a future acceleration of the object, which may be respectively derived from the current speed of the object, the current direction (e.g. and angular momentum) of the object, and/or the current acceleration of the object.

From block 510 the logic moves to block 5.12, where the logic presents on e.g. an at least partially transparent display coupled to a side window the extracted image (and/or a representation thereof) at a predicted current and/or real-time position, e.g. even though not currently viewable in the field of view (e.g. owing to another object obstructing its view), according to the extrapolation. For instance, the vehicle may extrapolate trajectories of identified moving objects that have moved outside of the field of view of the camera (and/or or get blocked by another object, such as a semi trailer), and display the trajectories on the side window where they are predicted to be in real time despite not being able to be seen so that the driver can stay away of them and thus avoid a collision.

Even more specifically, consider that a road has three lanes. A large truck is driving in the middle lane. Car number 1 is passing the track going in the left lane. Car number two is passing the truck at the same tune going in the right lane. Drivers in both ears have intention to change to middle lane after they pass the truck. They don't see each other, but need to be aware of each other. Side camera on car number one records data pertaining to car number two (e.g. velocity and/or acceleration) before they both start passing the truck. Car number one “knows” the speed of car number two before the passing starts and car number two is no longer present in the field of view of the camera of car number one. Car number one can in accordance with present principles extrapolate the trajectory of car number two and display an image of this car “behind the truck” (e.g., a representation of car number two may fee presented in pale colors and/or with dotted lines (e.g. lines of the lines, curves, and/or outline of car number two), etc. and overlaid on the image of the truck to indicate that vehicle is behind that truck, and/or may present (e.g. and overlay on another portion of the image such as fee portion showing the track) an image of car number two itself that was gathered by the camera prior to car number two disappearing from view), which will thus help inform the driver of car number one about potential danger of changing lanes to the middle right after they finish passing the truck based on the predicted movement of car number two while it is on the other side of the truck.

Now in reference to FIG. 6, it shows example logic that may be undertaken by a device such as the system 100 and/or a vehicle in accordance with present principles. Beginning at block 600, the logic determines to and/or receives a command to gather and present images on a side window in accordance with present principles. The logic then moves to block 602 where images for presentation are received and/or gathered. Thereafter, the logic moves to decision diamond 604, at which the logic determines whether any precipitation (e.g. ram, hail, snow, sleet) is evident in one or more of the images to be presented on the side window (e.g. using object recognition principles and/or software). Also at diamond 604, in addition to or in lieu of the foregoing, the logic may determine whether a weather condition is shown in one or more of the images, such as e.g. fog. A negative determination at diamond 604 causes the logic to move to block 606, where the logic presents at least some of the images on a side window in accordance with present principles.

However, an affirmative determination instead causes the logic to move to block 608. At block 608 the logic combines at least a portion of at least one other image (e.g. other than the one determined at diamond 604 to show precipitation and/or another weather condition) with the image showing the precipitation and/or other weather condition to produce another image (e.g. a stew image, an enhanced image of the original image (e.g. with the original image showing the precipitation being the base image of the enhanced image), and/or a representation of the original image showing the precipitation and/or other weather condition) that does not show the precipitation and/or other weather condition. The logic then proceeds to block 610, at which the logic presents the enhanced image on a side window in accordance with present principles.

As an example using the principles set forth above with respect to FIG. 6, in rainy or snowing conditions, a vehicle in accordance with present principles may filter out rain drops (and/or snow flakes) from images that are gathered by recognizing them in the image and combining several images so that resulting images are made of image fragments where rain drops (and/or snow flakes) were not detected, hence leading to a “clear” image not showing the precipitation. E.g., if one rain drop is falling down, and is visible on image one at coordinate X at time T, then it may be visible on image two at X+dX at time moment T+dT, Because X+dX is a different coordinate than X, a fragment of image one at coordinate X+dX is clear of rain drops and can be integrated into an enhanced image two at coordinate X+dX. Similarly, a fragment of image two at coordinate X is clear of rain drops and can be integrated into an enhanced image one at coordinate X. Thus, enhanced images are produced without the rain drop shown in image one at coordinate X and image two at X+dX.

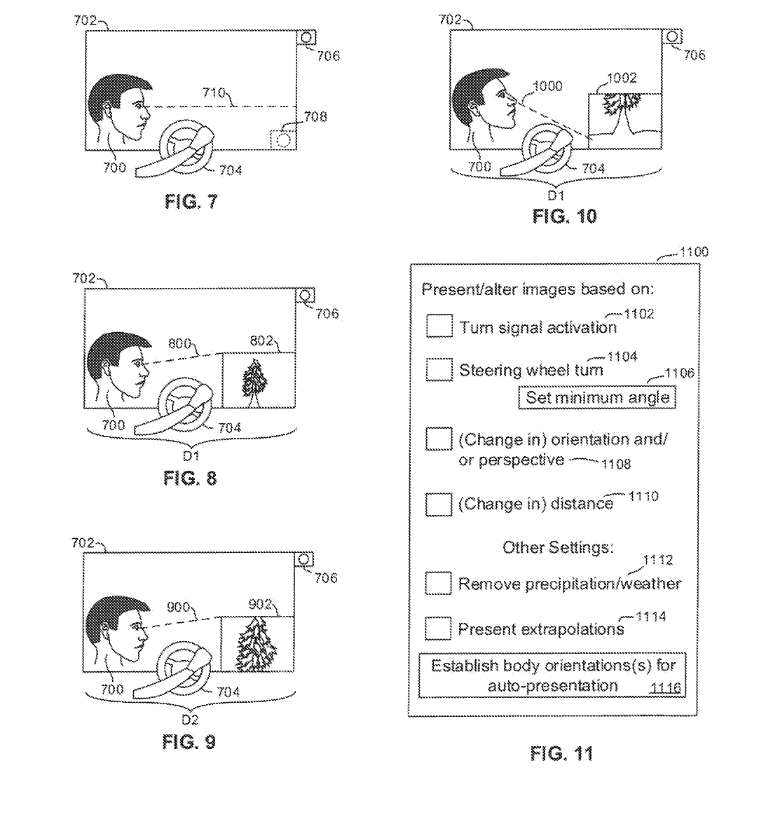

Continuing the detailed description in cross-reference to FIGS. 7-10, they show example illustrations in accordance with present principles of a driver 700 of a vehicle (much of which has been cut away in the figures for clarity) having a driver side window 702, a steering wheel 704, and camera 706 positioned (e.g. on an inside portion of the vehicle such as at or near the driver seat sun visor inside the passenger compartment of the vehicle) to gather images of the driver 700 while in the driver seat. FIG. 7 in particular shows a camera 708 which is understood to be mounted on the exterior of the vehicle and hence other side of a driver side window 702 than the driver 700 inside the passenger compartment.

Relative to the perspective shown in these figures, the camera 708 is understood to be positioned at least proximate to a bottom right corner of the window 702 on an exterior portion of the vehicle, the bottom right corner being understood to be a bottom exposed corner of the window 702 closest to the front of the vehicle. The camera 708 is directed to face toward the back of the vehicle, e.g. along an axis parallel to an (e.g. longitudinal) axis established by the length of the vehicle (e.g. from front to back) and, owing to be mounted on an exterior portion of the driver side of the vehicle, may move at various angles to gather images establishing driver side mirror perspectives (e.g. gather images from a particular perspective based on the driver's current head and eye orientations similar to that which would be seen if a driver side view mirror were actually present on the vehicle). Nonetheless, it is to be understood that in the present example no driver side view mirror is actually disposed on the vehicle.

Still specifically in reference to FIG. 7, it shows an axis 710 establishing a line of sight of the driver 700, which is understood to be directed ahead of the driver 700 and out of a front window and/or windshield (not shown for clarity) rather than toward the window 702. As shown in FIG. 8, an axis and/or line of sight 800 is shown establishing a line of sight of the driver 700 now directed toward the bottom right corner of the driver side window 702. Accordingly, the vehicle has, responsive to e.g. executing eye tracking software on images from the camera 706 to determine that the driver's focus is directed at least substantially toward (e.g. within a threshold number of degrees of directly at) the bottom right corner of the driver side window 702, used a projector and/or an at least partially transparent display integrated with the window 702 to present a representation 802 of a driver side mirror perspective at the bottom right corner of the window 702 to thus provide the perspective the driver 700 would see if he or she were to be looking out of that portion of the window 702 toward a driver side mirror if one existed. As shown in FIG. 8, the driver side mirror perspective in this instance includes a tree (understood to be behind the vehicle).

Before moving on to FIG. 9, it is to be understood that in the present example, the bottom right corner of the driver side window 702 which has been looked at by the driver 700 as represented by the axis 800 of the line of sight of the driver 700 is recognizable by the vehicle and/or predetermined (e.g. the dimensions of the area being established by a user) as being an area of the window 702 (e.g. an area less than the entire exposed area of the window 702) that, responsive to identification by the vehicle of it being looked at least substantially at by the driver 700 (e.g. using images from the camera 706), causes the vehicle to activate the display and/or projector and present the driver side minor perspective 802 on the window 702.

Furthermore, it is to also be understood that responsive to the driver 700 looking back out of the front windshield of the vehicle again (e.g. along an axis at least parallel to the axis 710) as determined by the vehicle, the representation 802 may be removed. However, note that in some embodiments, a representation of a driver side mirror perspective may always be presented at the predetermined area, regardless of whether the driver is looking at the predetermined area or not.

Also before moving on to FIG. 9, note that FIG. 8 shows a distance from the driver 700 (e.g. from a point on their head such as on the bridge of their nose between the eyes) to a front portion of the vehicle and/or steering wheel as D1 (e.g. distance one). Now in reference to FIG. 9, it may be appreciated that a distance between the driver 700 to the front portion of the vehicle and/or steering wheel is less than in FIG. 8, represented on FIG. 9 as D2 (e.g, distance two). The driver 700 has an axis and/or line of sight 900 still toward at least a portion of the bottom right corner of the window 702 but e.g. owing to both the repositioning of the driver 700 (e.g. leaning forward) and to a slight change of the direction of focus of the driver 700, the driver 700 is attempting to look at a particular portion of the representation 802 in more detail, and hence a different representation 902 of a side view mirror perspective is presented based on these changes as shown in FIG. 9.

Thus, as may be appreciated from FIG. 9, the illustration shows a (e.g. enlarged and/or zoomed in) side view mirror perspective of the top of the tree in particular. It is to be understood in reference to FIG. 9 that, using images received from the camera 706, the vehicle has determined that the driver's focus is on the top of the tree and, responsive to determining that the distance between the driver's eyes and the predetermined area of the window 702 has become less (and/or responsive to determining that the driver's focus is directed to the top of the tree specifically (e.g. for a threshold amount of time)), presents a zoomed in and/or magnified side view mirror perspective of the top of the tree.

Now discussing FIG. 10, the driver 700 is again at least substantially at distance D1 (e.g. and not at D2), but has his or her head tilted upward with an eye focus directed downward along axis and/or line of sight 1000 at a bottom portion of the predetermined area of the driver side window 702. Thus, as shown in FIG. 10, responsive to identification of the head tilt upward and/or eye focus along axis 1000, the vehicle presents representation 1002 of a different perspective of the same tree as described above but this time showing the bottom of the tree owing to the driver 700 directing his or her line of sight in a downward direction toward a bottom portion of the predetermined area of the window 702 from a higher vantage point. This change in the driver's positioning would result in a change in the perspective the driver 702 would view reflected light from a side view mirror on the vehicle, if one existed. Thus, this change in the driver's positioning in the present instance results in the representation 1002 being presented at the predetermined bottom right area of the window 702 to mimic the perspective the driver 700 would otherwise see using the side view mirror if it existed.

Note that the head tilt upward may have resulted in a slight change in the distance D1 to D1+dD (distance one plus a change in distance) but that e.g. owing to that change in distance not being more than a threshold change in distance (e.g. established by the user and/or identifiable by the vehicle), the vehicle does not zoom in or out more or less on the side view mirror perspective shown in representation 1002 but does still present the representation 1002 based on the direction of focus represented by axis 1000.

Continuing the detailed description now in reference to FIG. 11, it shows an example user .interface (UI) 1100 presentable on a display such as e.g. the on-board and/or dash display of a vehicle, and/or another device (e.g. a smart phone) in communication with the vehicle for undertaking present principles. The UI 1100 includes one or more options for presenting and/or altering representations of side view mirror perspectives, each of which is accompanied by a check box as shown that, when selected by a user such as the driver of a vehicle (e.g. using touch-based input) causes the vehicle to present representations accordingly on a side window. The options include an option 1102 to present and/or alter images based on activation of a turn signal, as well as an option 1104 to present and/or alter images based on the turn of a steering wheel. Note that a selector element 1106 is also shown for the option 1104 that, responsive to selection by the user, may cause another UI to be presented that a user may use to set a minimum and/or threshold turn angle for presenting and/or altering representations of side view mirror perspectives in accordance with present principles (e.g. by entering a number for the threshold turn angle, and/or based on prompts presented on this other UI to turn the steering wheel itself a particular angle which the vehicle may then identify and use as the threshold angle).

Still in reference to FIG. 11, the options may also include an option 1108 to present and/or alter images based on one or more (e.g. predetermined) perspectives of a user and/or body orientations of a user, and/or changes in one or more (e.g. predetermined) perspectives of a user and/or body orientations of a user. FIG. 11 also includes an option 1110 to present and/or alter images based the distance between the user and a point in the vehicle (e.g. the steering wheel, the bottom portion of the front windshield, etc.), and/or changes in such a distance. In reference to both the options 1108 and 1110, note that in some embodiments separate options (e.g. sub-options) may be presented for each one, with one respective sub-option being for (e.g. absolute) orientation and/or distance, and another respective sub-option being for changes in orientation and/or distance.

The UI 1100 may include still other features, such as e.g. a setting 1112 enableable responsive to selection of the corresponding cheek box shows to remove precipitation and/or weather-related things that may be shown in representations of side view mirror perspectives in accordance with present principles, and/or a setting 1114 enableable responsive to selection of the corresponding check box shown to present extrapolations of other moving objects in accordance with present principles. Note that the UI 1100 also includes a selector element 1116 selectable to automatically without further user input present another UI from which a user may establish one or more perspectives and/or body orientations for the user (e.g. driver) to be recognized by the vehicle as being perspectives and/or body orientations for which representations of side view mirror perspectives should be presented on corresponding side windows.

Without reference to any particular figure, in some embodiments sensors such as a 3D camera, a proximity sensor, an infrared sensor, and/or an ultra-sound locator, etc. (e.g. located at or near the rear of the vehicle such as on a rear bumper, and/or located at or near a side view camera) may be used analyze distances to and between objects that are to be included in a side view mirror perspective presented on a side window in accordance with present principles. The objects may or may not be moving but in either case, using one of the foregoing sensors for sensing distance allows a device in accordance with present principles to detect distance to the objects by e.g. using static pictures with a known accuracy. E.g., the accuracy of 3D distance measurements may increase as objects get closer (to the 3D camera), and “absolute” accuracy of ultra-sonic location may not change within certain distance range.

Also without reference to any particular figure, it is to be understood in accordance with present principles that a device (e.g. vehicle) may change an angle and/or area of view of side mirror view when a turn signal is activated and/or when the vehicle's steering wheel is turned in a certain direction. For example, if a driver turns on the right turn signal and/or steers to the fight, the right side-view camera may adjust its view area and/or field of view by moving right its field of view by the angle that corresponds to the angle by which steering wheel is turned, and thus the vehicle may present images establishing a side view mirror perspective accordingly.

Furthermore, in some embodiments changing the camera angle may depend on how sharply the steering wheel is turned. E.g., turning the steering wheel a relatively small amount may be interpreted by the vehicle as driver changing and/or about to change lanes slowly, so other vehicles that are remote (e.g. but moving relatively faster) are determined by the vehicle to be the most important objects of which the driver should be aware and accordingly the vehicle may determine that images thereof are to be presented on a side window. However, turning the steering wheel a relatively much higher amount may be interpreted by the vehicle as what is or will be a hard turn and/or fast lane change, and accordingly the vehicle may determine that images showing things in a (e.g. preconfigured and/or user-indicated) blind spot (and/or another area in a relatively close proximity (e.g. threshold area) of the vehicle) are most important for the driver to watch and accordingly present images having a field of view including the blind spot.

Still without reference to any particular figure, it is to be understood that a device In accordance with present principles may use eye tracking and/or face position tracking to change viewing angles and/or areas shown on a side window display using a side-view camera. Thus, if the driver looks at side-view earners display at a particular viewing angle, the view and/or field of view presented on the side window may be adjusted according to the face and/or eyes positions to emulate what would be seen from that angle using an actual side view mirror juxtaposed on the vehicle at a typical side view mirror position. For example, when the driver, while looking at the left-side camera and/or a predetermined area of the left passenger side window, moves their slightly head to the right, the camera may move right by the same angle to move view area and/or field of view to show an area closer to the car body.

Nonetheless, note that in some embodiments head and eye movements may be “amplified”, e.g. the view area displayed on the display of the side window may change in the same direction as the view in a conventional mirror would change relative to the driver, but by a relatively greater amount than the actual angle of driver movement so that driver does not have to move (e.g. lean) a lot to see what they want to see in the blind spot.

Still further, distance to a driver's face may be detected and used in accordance with present principles. Thus, e.g. if the driver moves their head closer to the mirror, with conventional side view mirrors this movement may result in increasing the view angle, which may in turn result in expanding the view area. Thus, a “digital mirror” in accordance with present principles may expand the viewing area when the driver moves their head closer to where such a mirror would be, resulting in providing the same view as would be seen using conventional mirror (e.g. but with less head movement) from that distance.

What's more, the present application recognizes that there may be certain instances where there are suboptimal light conditions for imaging. In such instances, a vehicle in accordance with present principles may combine several images (e.g. frames) from a side view camera to filter so-called dark noise and increase image contrast and/or brightness. E.g., moving objects (e.g., other vehicles) usually have lights, which are relatively easy to detect (e.g. by brightness level) and inform driver about, but for static objects when parking the vehicle at night, several images may be used to “smooth” dark noise out and produce a clear image(s) to assist the driver with parking the vehicle.

Also without reference to any particular figure, it is to be understood that an at feast partially transparent display in accordance with present principles may be e.g. installed in the side window itself. When disabled, the display and hence portion of the window including it may be transparent, and when enabled, the display shows images similar to what a driver would see in the side-view mirror as described herein.

Furthermore, it is to be understood that although the present application references a driver much of the time, present principles may apply to passengers in the vehicle as well. E.g., a passenger in a front passenger seat of the vehicle may look at a predetermined area of a side window most close to the passenger and, responsive to identification of such, the vehicle may present a side view mirror perspective at the predetermined area accordingly. Thus, e.g. the vehicle may determine, using images from a camera having the passenger in its field of view, whether the passenger is looking at or past the predetermined area based on the passenger's focus of their eyes and/or an identified local length of the passenger's sight, which may be compared to an identified distance from the passenger's eyes to the predetermined area, to determine whether the passenger is looking e.g. at or through the predetermined area and hence whether to present a side view mirror representation or not.

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a transitory signal and/or a signal per se.

While the particular PROJECTION OF IMAGES ON SIDE WINDOW OF VEHICLE is herein shown and described in detail, it is to be understood that the subject matter which is encompassed by the present application is limited only by the claims.

What is claimed is:

1. A vehicle, comprising:
a vehicle body;
a processor;
a camera disposed on the vehicle body which is accessible to the processor;
at least one window onto which at least one image is presentable; and
memory comprising instructions executable by the processor to:
receive data from the camera; and
based at least in part on the data, present on the window at least one image corresponding to a representation of a field of view of a mirror, wherein the field of view is identified at least in part based on a current position of at least a portion of a driver.

2. The vehicle of claim 1, further comprising:
at least one sensor, wherein input from the sensor is used to identify the current position of at least the portion of the driver.

3. The vehicle of claim 1, wherein the vehicle comprises one or more of:
an at least partially transparent display on the window which presents the at least one image of the field of view, and a projector which projects onto the window the at least one image of the field of view.

4. The vehicle of claim 1, wherein the representation is presented responsive to a determination that the driver is looking at least toward a side of the vehicle and wherein the representation is not presented otherwise.

5. The vehicle of claim 4, wherein the side of the vehicle comprises the window.

6. The vehicle of claim 1, wherein data from a sensor is used to at least in part establish portrayals of spatial distances of objects, relative to each other, in the image corresponding to the representation, wherein the sensor comprises one or more of: a three dimensional camera, a proximity sensor, an infrared sensor, and an ultra sound transceiver.

7. A method, comprising:
receiving at least one image from a earners; and
at least in part based on the at least one image, presenting on a display a representation of a field of view of a side view mirror of a vehicle.

8. The method of claim 7, wherein the representation is presented on an at least partially transparent display integrated with a window of the vehicle.

9. The method of claim 7, wherein the representation of the field of view of the side view mirror is a representation of a field of view of a passenger side view mirror, and wherein the window is a passenger side window.

10. The method of claim 7, comprising:
receiving plural images from the camera;
identifying precipitation in at least a first image of the plural images; and
responsive to the identifying of the precipitation and based on at least a second image of the plural images, presenting on the display a representation of the first image that does not show at least some of the precipitation in the first image as received from the camera.

11. A device, comprising:
at least one processor;
at least one camera accessible to the processor;
at least one display accessible to the processor; and
at least one memory accessible to the processor and bearing instructions executable by the processor to:
receive data from the camera; and
based at least in part on the data, control the display to present at least one image on at least a portion of a window of a vehicle.

12. The device of claim 11, wherein the instructions are executable by the processor to:
control the display to present at least one image on the window responsive to a determination that a turn signal in the vehicle is activated.

13. The device of claim 12, wherein the instructions are executable by the processor to:
determine to control the display to not present at least one image on the window responsive at least in part to a determination that a turn signal in the vehicle is not activated.

14. The device of claim 11, wherein the instructions are executable by the processor to:
control the display to present at least one image on the window responsive to a determination based at least in part on data from the camera that a current body orientation of a driver satisfies a body orientation criterion, and determine to control the display to not present at least one image on the window responsive to a determination based at least in part on data from the camera that a current body orientation of the driver does not satisfy the body orientation criterion.

15. The device of claim 12, wherein the instructions are executable by the processor to:
control the display to present at least one image on the window responsive to a determination based at least in part on data from the camera that a current body orientation of a driver satisfies a body orientation criterion, and determine to control the display to not present at least one image on the window responsive to a determination based at least in part on data from the camera that a current body orientation of the driver does not satisfy the body orientation criterion.

16. The device of claim 11, wherein the instructions are executable by the processor to:
control the display to alter presentation of images on the window responsive to a determination that a turn signal in the vehicle is activated.

17. The device of claim 11, wherein the instructions are executable by the processor to:
control the display to alter presentation of images on the window responsive to a determination that a steering wheel is turned at an angle which satisfies an angular turn criterion.

18. The device of claim 11, wherein the instructions are executable by the processor to:
control the display to alter presentation of images on the window from a first projection of images having a first field of view to a second projection of images having a second field of view different from the first field of view responsive at least in part to identification of a change of a body orientation of a driver.

19. The device of claim 11, wherein the instructions are executable by the processor to:
control the display to alter presentation of images on the window from a first projection of images having a first field of view to a second projection of images having a second field of view different from the first field of view responsive at least in part to identification of a particular body orientation of a driver.

20. The device of claim 11, wherein the instructions are executable by the processor to:
control the display to alter presentation of images on the window from a first projection of images having a first field of view to a second projection of images having a second field of view different from the first field of view responsive to a determination that a distance between the window and at least a portion of the driver has changed.

21. The device of claim 11, wherein the at least a portion of the driver comprises at least a portion of the head of the driver.

22. The apparatus of claim 11, wherein the instructions are executable by the processor to:
basal on images received from the camera, identify an object proximate to the vehicle as moving and extrapolate at least one future position of the moving object; and
control the display to present on the window at least one image comprising at least one of: a representation of the moving object at the future position, and the moving object at the future position.

23. The device of claim 11, wherein the display is selected from the group consisting of: a display coupled to at least a portion of the window, a projector which projects images onto the window.
